(19) United States
(12) Patent Application Publication
(10) Pub. No.: US 2002/0009528 A1
(43) Pub. Date: Jan. 24, 2002

(54) VEGETABLE MEAT

(76) Inventor: BENIAMINO ANZALONE, ROMA (IT)

Correspondence Address: YOUNG & THOMPSON, 745 SOUTH 23RD STREET 2ND FLOOR, ARLINGTON, VA, 22202

(21) Appl. No.: 09/230,545

(22) PCT Filed: May 5, 1997
(86) PCT No.: PCT/IB97/00488

(30) Foreign Application Priority Data
Jul. 30, 1996 (IT) RM96A000549
Mar. 26, 1997 (EP) 971050240

(51) Int. Cl. A21D 2/36

(52) U.S. Cl. 426/549; 426/550; 426/634

(57) ABSTRACT

Vegetable meat is a high nutritional vegetable food, which uses gluten proteins, minerals, vitamins and food fibres of cereals and legumes. Vegetable meat is obtained by mixing a percentage of gluten with a percentage of one or more cereal flowers, or with a percentage of one or more legume flowers, or with a percentage of one or more cereal and legume flowers together. This mixture is seasoned with natural spices according to the taste required and then kneaded and worked with water or vegetable broth and afterwards boiled. By changing the various percentages of the components and the different kinds of flowers, various types of vegetable meat are obtained: steak, stew, mince, hamburger, sausage, pizzaiola, mortadella, ham, bresaola, guanciale, etc. It has a cylindrical shape with rounded ends.

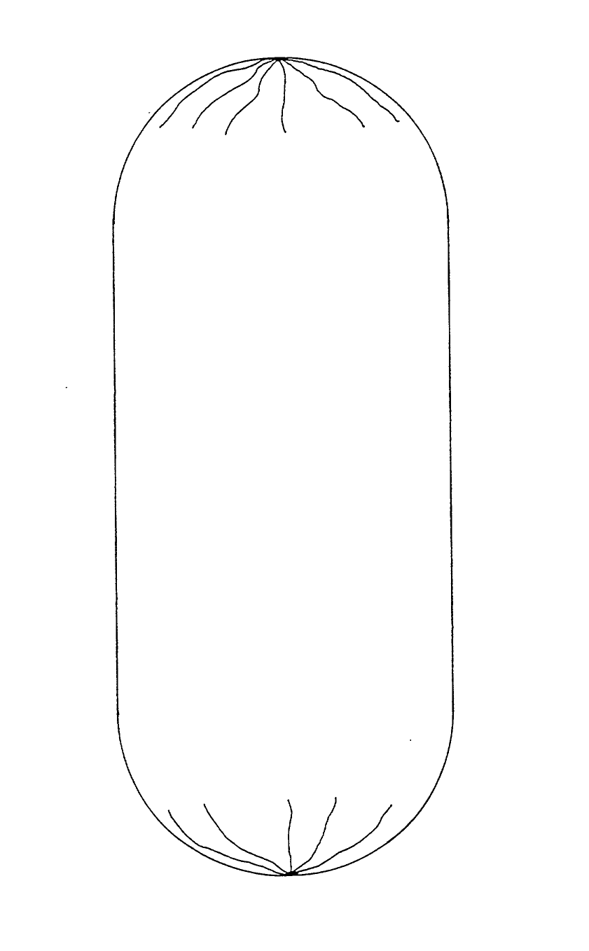

### Tecnical Field The invention concerns a high nutritional value food in alternative to animal meat.

### Background Art

Vegetable meat is composed of natural products based on gluten, cereal flour and legume flour.

This mixture enables a high percentage of protein to be used, which is concentrated in the gluten, minerals (especially iron), vitamins and the food fibres of cereals and legumes.

Its structure enable it to be used as food to be consumed cold to the flavour of mortadella, ham, bresaola, guanciale etc., or hot as steak, stew, mince, hamburger, sausage, pizzaiola, etc.

Other vegetable food, with high nutritional value, know by the writer, are Seitan and Soya by products like soya steak and soya stew.

The latters are not finished like vegetable meat, because either they lack of same amino acids or of food fibres.

Moreover, they are unable to produce all types of meat mentioned above (mortadetla, etc. . . . ) .

### Disclosure of Invention

The invention thus concerns a process for production of vegetable meat as set out in the claims.

Haw vegetable meat is made: A percentage of gluten from 45% to 99.9% is mixed with a percentage of one or more cereal flours from 0.1% to 55%, or with a percentage of one or more legume flours from 0.1% to 55%, or with a percentage of one or more cereal and legume flours together from 0.1% to 55%.

This mixture is seasoned with various spices and after being kneaded and worked with water or vegetable broth, afterwards the pieces of required size are prepared and boiled for about two hours.

The list of cereals used for cereal flours is: hard grain, soft grain, buckwheat, kamut grain, oats, barley, pearl barley, naize, rye, spelt, rice.

The list of legumes used for legume flours is: chickpea, pea, broad bean, lenil, bean soya bean, chickling.

The kind of cereal or legume flours, which is used, can be wholemeal, fine, extra fine, bran.

The quality of gluten, cereal and legume flours used can be biological or non-biological. Vegetable meat comes in the form of a piece of meat such as a cylindrical shaped filet with rounded ends.

Its weight may be 0.5 kg., 1 kg., 2 kg., 3 kg., etc. . . . , in order to obtain this cylindrical shape, synthetic casings for salami or other forcemeat products may be used.

The list of seasonings used is: garlic, fennel seeds, rosemary, pistachio, paprika, black pepper, chili, salt, basil, parsley, extra pure olive oil, yeast extact, etc. . . . The amount of water or vegetable broth for the flour dough is between 0.8 litres to 1 litre for every kilogramme of flour mixture.

The various kinds of vegetable meat named above (steak, stew, hamburger, mortadella, ham, etc. . . . ) are obtained by playing around with the percentages of gluten and of cereal and legume flours which have been used, also with the different types of cereal and legume flowers (wholemeal, fine, extra fine, bran ), and as well as with the ditterent types of spices used. The advantages of vegetablew meat are: 1) It give anyone not eating meat (vegetarians), anyone who cannot eat it because of colesterol, uric acids, or digestive problems, the chance to have complete alternative to animal meat (due to its nutritional value as well as to the range of different kinds of vegetable meat). 2) It can be kept in a fridge in a vacuum-sealed package for 30 days and frozen for 12 months.

### Best Mode for Carrying Out the Invention

Let us give an example of how to come up with one kind of vegetable meat: “Steak”.

The following flours are mixed: gluten 700 grammes, wholemeal chickpea 200 grammes, wholemeal oats 70 grammes, wholemeal spelt 30 grammes, with 1 litre of vegetable broth and seasoned with salt, pepper, rosemary, extra olive oil.

the mixture is kneaded until everything is blended and is left to stand for twenty minutes, then the cylindrical shaped pieces of meat are prepared using synthetic casing for salami and it is boiled for one hour and forty five minutes.

### Industrial Applicability

It is extremely suitable for being produced with a modern industrial system, in fact by using the latest flour mixers and modem boilers for cooking and with an automatic system for vacuum-sealed packing, the product can be made in extremely large quantities.

1. A process for producing “vegetable meat”, i.e. a vegetable food which is alternative to meat, which process comprises the step of:
a) providing a mixture of 45 to 99.9% by weight of gluten and 0.1 to 55% by weight of a flour selected from the group consisting of cereal flours, legume flours and mixtures thereof,
b) admixing said mixture of gluten and flour with water or vegetable broth, in a ratio of 1 kg of said mixture per 0.8 to 1.0 lt. of water or vegetable broth,
c) kneading until a dough is obtained,
d) shaping the dough into cylindrical pieces by means of syntetic casings for salami or similar forcemeat, e) boiling the thus obtained shaped pieces for 105 to 120 minutes.

2. A process according to claim 1, wherein the flour is a cereal flour.

3. A process according to any one of claims 1 and 2, wherein the cereal flour is selected from the group comprising hard wheat flour, soft wheat flour, buckwheat flour, kamut grain flour, oat flour, barley flour, pearl barley flour, maize flour, rye flour, spelt flour, rice flour.

4. A process according to claim 1, wherein the flour is legume flour.

5. A process according to any one of claims 1 and 4, wherein the legume flour is seiected from the group comprising chickpea flour, pea flour, broad bean flour, lentil flour, soy bean flour, chichilin flour.

6. A process according to claim 1, wherein the flour is a mixture of a cereal flour and legume flour.

7. A process according to claim 1, wherein the flour is a mixture of one legume flour and at least two cereal flours.

8. A process according to claim 1, wherein the flour is a mixture of a cereal flour and at least two legume flours.

9. A process according to claim 1 , wherein the flour is a mixture of at least two cereal flours and at least two legume flours.

10. A process according to any one of claims 1 to 9, wherein the cereal and/or legume flour is wholemeal flour, fine flour, extra fine flour or bran.

11. A process according to any one of the preceding claims wherein the gluten and/or the cereal flour and/or the legume flour is biological. 12. A process according to any one of the preceding claims, further comprising the step of seasoning the mixture of gluten and flour.

13. A process according to claim 12, wherein said seasoning step is carried out by adding at least one ingredient select from the group compresing garlic, fennel seeds, rosemary, pistachio, paprika, black pepper, chili, salt, basil, parsly, extra pure olive oil, yeast extract.

14. A process according to any one of the preceding claims, wherein said mixture of gluten and flour is admixed with water.

15. A process according to any one of claims 1 to 13 wherein said mixture of gluten and flour is admixed with vegetable broth.
